(19) United States
(12) Patent Application Publication
(10) Pub. No.: US 2015/0146627 A1
(43) Pub. Date: May 28, 2015

(54) METHODS AND APPARATUS TO IMPROVE PLMN SEARCH TIME

(71) Applicant: QUALCOMM Incorporated, San Diego, CA (US)

(72) Inventors: Manjunatha Subbamma ANANDA, Chickballapur (IN); Pankaj BANSAL, Jaipur (IN); Siddhant MEHROTRA, Lucknow (IN); Sivasubramanian RAMALINGAM, Hyderabad (IN)

(73) Assignee: QUALCOMM Incorporated, San Diego, CA (US)

(21) Appl. No.: 14/262,362

(22) Filed: Apr. 25, 2014

Related U.S. Application Data
(60) Provisional application No. 61/907,700, filed on Nov. 22, 2013.

(51) Int. Cl. H04W 8/00; H04W 72/08

(52) U.S. Cl. CPC H04W 8/005; H04W 72/085
USPC 370/329

(57) ABSTRACT

The disclosure provides methods and apparatus to improve public land mobile network search time. A user equipment (UE) may determine a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels. The subset of channels may be scanned to determine a signal strength of each channel in the subset. The UE may rank each channel in the subset according to the determined signal strength of the channel and attempt to acquire a cell using a channel in the subset based on the ranking.

The present application for patent claims priority to Provisional Application No. 61/907,700 entitled “A NOVEL METHOD TO IMPROVE PLMN SEARCH TIME IN WCDMA” filed Nov. 22, 2013, and assigned to the assignee hereof and hereby expressly incorporated by reference herein.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In a UMTS system a wireless device may perform a full scan when out-of-service (OOS), when in limited service recovery, or for a manual public land mobile network (MPLMN) search. A full band scan time may vary from few seconds to a few minutes depending on the number of bands supported by a wireless radio access technology (RAT). Since this full scan takes lot of time, the UE would stay OOS until it finds service on suitable cell and miss any mobile originated (MO)/mobile terminated (MT) activities. Also the power consumption of a full scan may be higher as the number of frequencies to be scanned is higher. This problem may be compounded in multi-SIM solutions where multiple scans may be necessary.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The disclosure provides methods and apparatus to improve public land mobile network search time. A user equipment (UE) may determine a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels. The subset of channels may be scanned to determine a signal strength of each channel in the subset. The UE may rank each channel in the subset according to the determined signal strength of the channel and attempt to acquire a cell using a channel in the subset based on the ranking.

In an aspect, the present disclosure relates to a method of wireless communication for performing a public land mobile network (PLMN) search. The method includes determining a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels. The method further includes scanning the subset of channels to determine a signal strength of each channel; ranking each channel in the subset according to the determined signal strength of the channel; and attempting to acquire a cell using a channel in the subset based on the ranking.

In another aspect, the present disclosure provides to an apparatus for performing a PLMN search. The apparatus includes means for determining a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels. The apparatus further includes means for scanning the subset of channels to determine a signal strength of each channel; means for ranking the subset of channels according to the determined signal strength of the channel; and means for attempting to acquire a cell using a channel in the subset based on the ranking.

Another aspect of the disclosure provides a computer program product including a non-transitory computer-readable medium. The non-transitory computer-readable medium includes code for determining a subset of channels within a frequency band based on a stored identifier of a channel used by a previously acquired cell, each channel in the subset being spaced from the channel of the previously acquired cell by a different multiple of a set spacing, the set spacing being greater than a spacing between adjacent channels. The non-transitory computer-readable medium also includes code for scanning the subset of channels to determine a signal strength of each channel; ranking each channel in the subset according to the determined signal strength of the channel; and attempting to acquire a cell using a channel in the subset based on the ranking.

Yet another aspect of the disclosure provides an apparatus for wireless communication. The apparatus includes at least one processor and a memory coupled to the at least one processor. The at least one processor is configured to: determine a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels; scan the subset of channels to determine a signal strength of each channel; rank each channel in the subset according to the signal strength of the channel; and attempt to acquire a cell using a channel in the subset based on the ranking.

### BRIEF DESCRIPTION OF THE DRAWINGS

FIG. 1 is a diagram illustrating a wireless device in communication with a radio network.

FIG. 2 is a flowchart illustrating an example of a method of performing a PLMN search.

FIG. 3 is a flowchart illustrating another example of a method of performing a PLMN search.

FIG. 4 is a diagram illustrating an example of sets of channels utilized in a radio network.

FIG. 5 is a diagram illustrating an example of a hardware implementation for an apparatus employing a processing system.

FIG. 6 is a block diagram conceptually illustrating an example of a telecommunications system.

FIG. 7 is a conceptual diagram illustrating an example of an access network.

FIG. 8 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a public land mobile network (PLMN) scan, a wireless device scans one or more frequency bands for a signal provided by a network. In order to identify a PLMN, the wireless device may attempt to acquire a cell by synchronizing with a received signal to determine a primary scrambling code used by the cell. A wireless device may attempt to acquire a cell using a channel or frequency where received signal strength is observed. The wireless device may be unable to acquire a cell if the attempted frequency is not the center frequency used by the cell. Such synchronization attempts may be time consuming and form a substantial portion of the total time for a PLMN search.

A PLMN may use particular defined channel. For example, the universal terrestrial radio access (UTRA) Absolute Radio Frequency Channel Number (UARFCN) may define a channel centered on a multiple of 200 kHz. As used herein, the term “channel” may refer to a band of frequencies that may be used to transmit electric signals. In an aspect, a channel may be identified by, for example, a UARFCN or a corresponding center frequency. In a wideband code division multiple access (WCDMA) network, base stations may be configured to use center frequencies that are spaced further apart than 200 kHz. In particular, WCDMA frequencies may be spaced at approximately 5 MHz or 25 UARFCNs. Accordingly, not every UARFCN may be used as a center frequency in a WCDMA network. When a wireless device performs a PLMN scan for a WCDMA network, the wireless device may more quickly perform the search by attempting to acquire those channels that are spaced at multiples of 5 MHz from a known WCDMA center frequency. The wireless device may use a stored channel identifier of a previously acquired cell to predict other likely channels or center frequencies. The wireless device may sort the predicted channels or frequencies by received signal strength (e.g. a received signal strength indicator (RSSI)), and attempt to acquire a PLMN at each predicted channel or frequency in descending order of signal strength. The wireless device may also attempt to acquire nearby channels, such as channels at plus or minus 2 UARFCN from a predicted channel, when acquisition on a predicted channel fails. The wireless device may eliminate channels or frequencies within 5 MHz of a discovered WCDMA center frequency, as well as other scanned channels, when performing a full band scan.

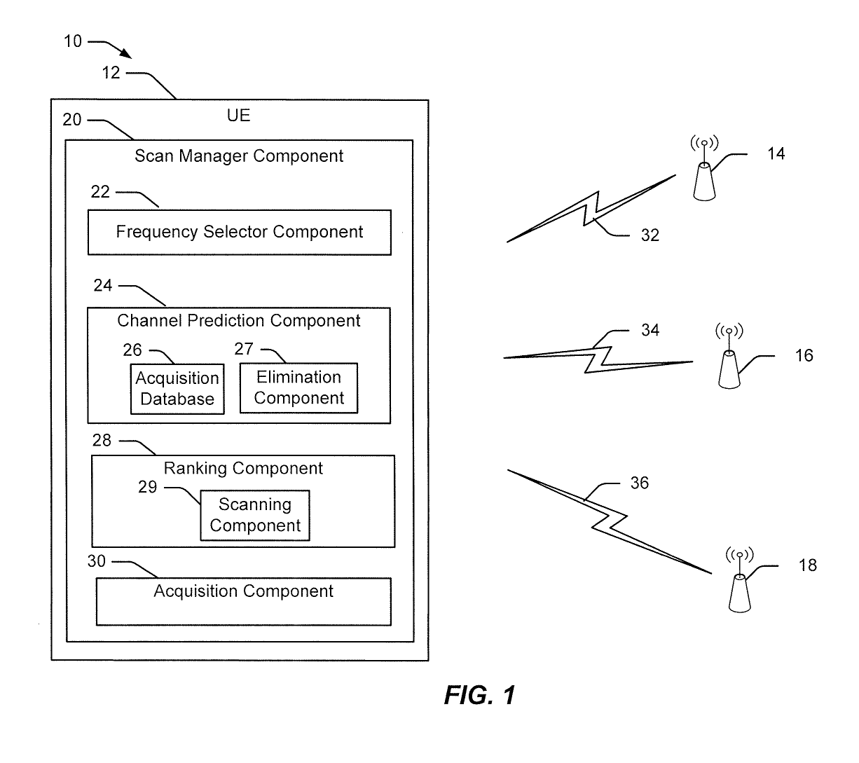

Referring to FIG. 1, in an aspect, a wireless communication system 10 includes a user equipment (UE) 12 having a scan manager component 20 configured to perform a PLMN search. For example, scan manager component 20 may include a processor configured to scan a range of frequencies for a base station such as base stations 14, 16, or 18 utilizing communications frequencies 32, 34, 36, respectively. The scan manager component 20 may be configured to perform a multi-level scan including a database scan, an elimination scan, and a full band scan. In the database scan, the scan manager component 20 may attempt to acquire a cell using one or more channel identifiers of a previously acquired cell stored in an acquisition database 26. In the elimination scan, the scan manager component 20 may attempt to acquire a cell that uses one of a subset of channels or frequencies most likely to be utilized by another cell given the one or more previously acquired cells. In the full band scan, the scan manager component 20 may attempt to acquire a cell using each frequency or channel that the wireless device is capable of using. During the full band scan, the scan manager component 20 may skip those channels or frequencies scanned or acquired during the database scan and the elimination scan.

The scan manager component 20 may further include a frequency selector component 22, a channel prediction component 24, a ranking component 28, and an acquisition component 30.

The frequency selector component 22 may include hardware or means for determining a set of channels or frequencies to be included in a full band scan. The set of frequencies may be, for example, a range of UARFCNs. That is, the frequency selector component 22 may select a set of adjacent channels within a frequency band. The adjacent channels may have center frequencies spaced a first distance, for example, 200 kHz, apart. The set of frequencies may be based on the capabilities of the UE 12. For example, the set of frequencies may include only those frequencies which an antenna or receive chain of the UE 12 is configured to receive. The set of frequencies may be based on a frequency band. A set of frequencies may be determined for each frequency band used by the UE 12, or all frequency bands that the UE 12 is configured to use may be combined in a single set.

The channel prediction component 24 may include hardware or means for determining a subset of channels or frequencies (predicted subset) to be included in an elimination scan. The channel prediction component 24 may select channels or frequencies for the predicted subset that are most likely to be used by cells. The channel prediction component 24 may include the acquisition database 26, which may store one or more identifiers of previously acquired channels such as, for example, center frequencies, channel numbers and/or corresponding cell information. The channel prediction component 24 may select channels or frequencies for the elimination scan based on multiples of a set spacing from a channel or center frequency used by a previously acquired cell. A set spacing may be a separation between two frequencies measured in hertz. For example, a set spacing between two channels may be a separation between the center frequencies of the channels. A set spacing may also be expressed as a number of UARFCN because each UARFCN identifies a channel spaced 200 kHz from an adjacent channel. The set spacing may depend on a radio access technology (RAT) configured for the UE 12. For example, if WCDMA is used or is preferred by the UE 12, the set spacing may be 25 UARFCNs or 5 MHz. The set spacing may also vary based on a geographic region. For example, regulations or bandwidth allocations in a country may allow variations in spacing between center frequencies used for a RAT. In one example, the set spacing for WCDMA may vary between 4.6 MHz and 5.4 MHz in some countries. The channel prediction component 24 may include a look-up table for determining the set spacing based on the RAT, geographic region, or any other predictor of spacing. The channel prediction component 24 may select any number of channels within the full set, each channel in the subset being spaced from the channel used by the previously acquired cell by a different multiple of the set spacing.

In an aspect, identifiers of more than one previously acquired cell may be stored in the acquisition database 26. Cells using lower frequencies may have greater coverage in terms of distance. Accordingly, it may be more likely that other cells would use frequencies spaced at the set spacing from the cell using the lowest frequency. In such a case, the channel prediction component 24 may select a first subset of channels or frequencies spaced at different multiples of the set spacing from the lowest frequency used by one of the cells and a second set of channels or frequencies spaced at different multiples of the set spacing from a greater frequency used by one of the cells. The first subset of channels or frequencies may include only those channels or frequencies less than the greater frequency. The second subset of channels or frequencies may include only those channels or frequencies greater than the greater frequency. A predicted subset for an elimination scan may include both the first and second subsets.

The channel prediction component 24 may also include an elimination component 27 configured to remove channels from the full set of channels for a full band scan. The elimination component 27 may select channels that are unlikely to be used by another cell. For example, the elimination component 27 may remove channels that are located within the set spacing from a channel used by a successfully acquired cell. The elimination component 27 may also remove any channel for which an attempted acquisition procedure is unsuccessful.

Ranking component 28 may include hardware or means for ranking one or more channels or frequencies of the selected subset. The ranking component 28 may include a scanning component 29. For example, the scanning component 29 may include an antenna, receive chain, and receive processor. The scanning component 29 may scan each of the channels or frequencies in the predicted subset and determine a received signal strength for each scanned channel or frequency. The received signal strength may be, for example, an RSSI.

The ranking component 28 may rank the frequencies of the predicted subset in descending order according to the received signal strength. The ranking component 28 may also determine a received signal strength threshold. A received signal strength threshold may be a minimum signal strength required to decode a signal or other minimum signal strength. For example, the received signal strength threshold may be set to −110 dBm. The ranking component 28 may remove any channel or frequency from the predicted subset that does not satisfy the received signal strength threshold. The ranking may determine the order, e.g. strongest to weakest, in which the acquisition component 30 attempts to acquire the frequencies. The ranking component 28 may also stop a search when the signal strength of the next ranked channel or frequency is less than the threshold.

The acquisition component 30 may include hardware or means for performing an acquisition procedure on a frequency. For example, the acquisition component 30 may include an antenna, receive chain, and receive processor. The acquisition procedure may include receiving a set of samples on the channel or frequency and correlating the samples to synchronize the signal to determine a primary scrambling code (PSC) used by the cell. An attempt to acquire a cell using a channel or frequency may include at least receiving a set of samples on the channel or frequency. If an attempt to acquire a cell is successful, the UE 12 may determine the PSC used by the cell. An attempt to acquire a cell may be considered unsuccessful when the UE 12 is unable to determine the PSC used by the cell. The UE 12 may also decode at least some information transmitted by a cell. The acquisition procedure may further include receiving and decoding information transmitted by a cell, for example, system information blocks (SIBs). Once the UE 12 has acquired a cell, the UE 12 may determine whether to camp on the acquired cell. For example, the UE 12 may perform additional measurements to determine the quality of the cell before determining whether to camp on the cell. The UE 12 may request a connection to the PLMN of the acquired cell. The network may determine whether the UE 12 is allowed to access the network based on, for example, subscription information.

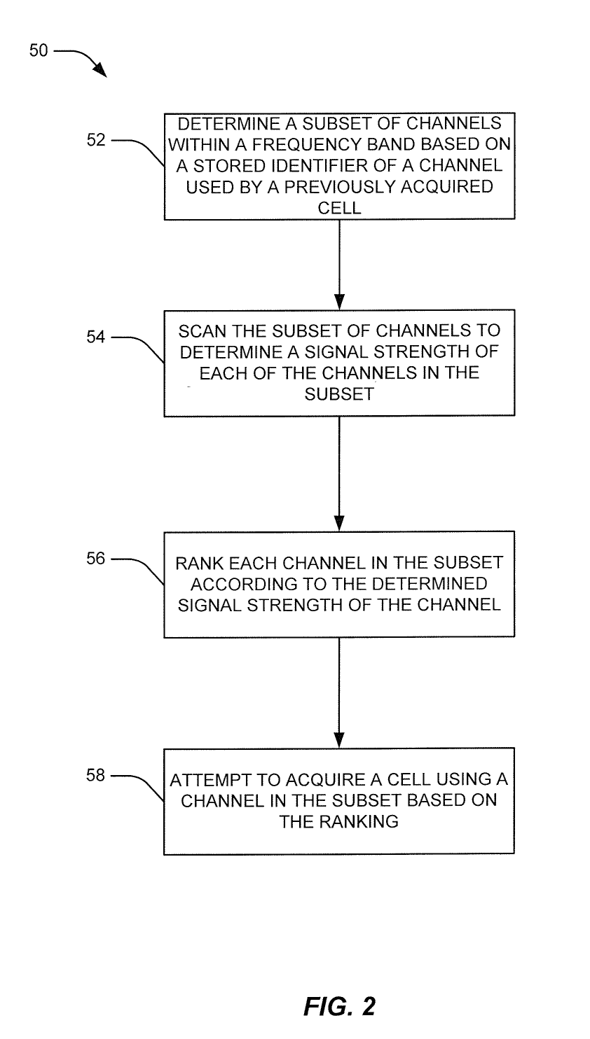

FIG. 2 is a flowchart illustrating a method 50 of performing a PLMN search. Referring to FIG. 1, in an operational aspect, a UE 12 may perform various aspects of a method 50 for a PLMN search. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, the method 50 includes, at block 52, determining a subset of channels within a frequency band based on a stored identifier of a channel used by a previously acquired cell. The channel prediction component 24 may perform the operations illustrated in block 52. The channel prediction component 24 may determine the subset of channels by accessing acquisition database 26 to obtain the stored channel identifier. The stored channel identifier may be, for example, a frequency or a UARFCN. The UE 12 may use acquisition component 30 to attempt to re-acquire the cell using the stored channel identifier to determine whether the stored information is correct before determining the channel subset. For example, the stored information may no longer be applicable if the UE 12 has changed geographic locations.

The predicted subset may be selected by the channel prediction component 24 based on multiples of a set spacing from a previously acquired channel. Each channel in the subset may be spaced from the channel of the previously acquired cell by a different multiple of a set spacing. The set spacing may be greater than a spacing between adjacent or contiguous channels. The set spacing may depend on a RAT configured for the UE 12. For example, if WCDMA is used or is preferred by the UE 12, the set spacing may be 5 MHz or 25 UARFCNs. As an example, a 2100 MHz band may include UARFCNs 10562-10838. If the channel with UARFCN 10757 (2151.4 MHz) is stored for a previously acquired cell, the subset may include UARFCNs 10582, 10607, 10632, 10657, 10682, 10707, 10732, 10782, 10807, and 10832.

In block 54, the method 50 may include scanning the predicted subset of channels to determine a signal strength of each of the channels in the subset. The scanning component 29 may perform the operations illustrated in block 54. The scanning component 29 may determine the received signal strength at each of the channels using an antenna and receive chain. Determining the received signal strength may be relatively fast compared to acquiring a cell because the scanning component 29 does not need to wait for any particular information or need to decode the signal.

In block 56, the method 50 may include ranking each channel in the subset according to the determined signal strength of the channel. The ranking component 28 may perform the operations illustrated in block 56. The ranking component 28 may rank the channels in order of descending signal strength such that the channel having the strongest signal is ranked first. The ranking component 28 may also rank the subset of channels based on a signal strength threshold. For example, the ranking component 28 may determine that channels having a signal strength less than the signal strength threshold may be eliminated from the search. The channels having a signal strength less than the signal strength threshold may be added to an elimination subset or ignored during an elimination scan.

In block 58, the method 50 may include attempting to acquire a cell using a channel in the subset based on the ranking. The acquisition component 30 may perform the operations illustrated in block 58. The acquisition component 30 may perform an acquisition procedure on a channel selected based on the ranking. The acquisition component 30 may receive samples on the selected channel and attempt to decode the received samples. The acquisition procedure may be successful if the acquisition component is able to determine a PSC of a cell using the selected channel. Successful acquisition may indicate that a PLMN is providing a cell using the selected channel. The acquisition procedure may be considered unsuccessful if the acquisition component is unable to determine a PSC based on the received samples. Unsuccessful acquisition may not be conclusive as to whether a PLMN is providing a cell using the selected channel. For example, the cell may exist, but the received signal may be too weak to correctly decode.

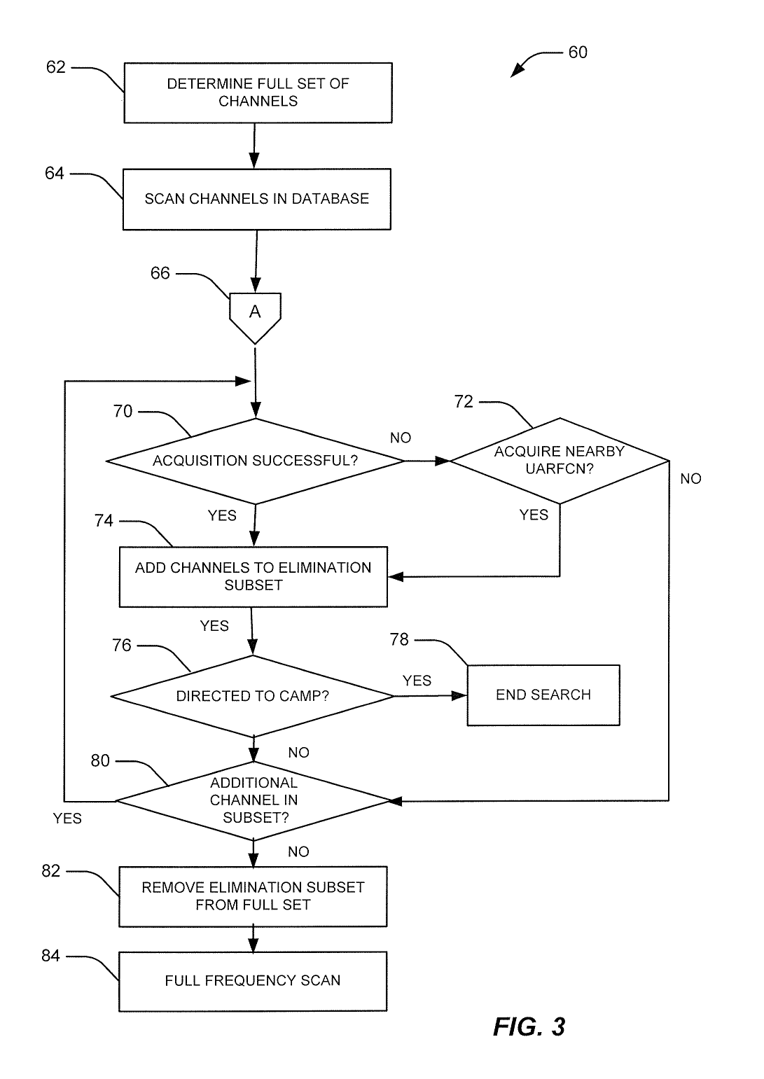

FIG. 3 is a flowchart illustrating another example of a method 60 of performing a PLMN search. Referring to FIG. 1, in an operational aspect, a UE 12 may perform various aspects of a method 60 for a PLMN search. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 62, the method 60 includes selecting a full set of channels for a full PLMN search. A full PLMN search may be a search encompassing every channel usable by a wireless device within a particular frequency band. For example, a full PLMN search may include making a determination for each channel within the particular frequency band as to whether a cell using the channel is available. The frequency selector component 22 may perform the operations illustrated in block 62. The frequency selector component 22 may select the full set of channels. The full set of channels may include frequencies to be included in a full band scan. The full set of channels may be, for example, a range of UARFCNs. That is, the set of channels may include frequencies spaced a minimal distance, for example, 200 kHz, from each other. The full set of channels may be based on the capabilities of the UE 12. For example, the full set of channels may include only those channels or frequencies which an antenna or receive chain of the UE 12 is configured to receive. The full set of channels may be based on a frequency band. A full set of channels may be determined for each frequency band used by the UE 12. Alternatively, if a UE 12 is configured to use a plurality of frequency bands, the full set of channels for all of the frequency bands may be combined in a single set.

At block 64, the method 60 may include requiring a previously acquired cell using a stored identifier of a channel used by the cell. The operations illustrated in block 64 may be performed by the acquisition component 30 using the acquisition database 26. The acquisition database 26 may include the identifier of one or more previously acquired cells. For example, the acquisition database 26 may store a channel or frequency of one or more previously acquired cells. The acquisition component 30 may attempt to acquire the one or more previously acquired cells. The successfully acquired cells may be used to predict channels for an elimination scan. If the acquisition component 30 is unable to acquire any of the previously acquired cells, the scan manager component 20 may skip the elimination scan and perform a full scan.

At block 66, the method 60 may include all or part of method 50 described above with respect to FIG. 2. In general, the UE 12 may generate a ranked predicted subset of channels to use in the elimination scan and attempt to acquire a cell using one of the channels in the predicted subset.

In block 70, the UE 12 may determine whether the attempt to acquire a cell using the selected channel was successful. The operations illustrated in block 70 may be performed by the acquisition component 30. The acquisition component 30 may provide the scan manager component 20 with an indication of whether the acquisition procedure for the selected channel was successful. If the acquisition was successful, the method 60 may proceed to block 74. If the acquisition was unsuccessful, the method 60 may proceed to block 72.

In block 72, the method 70 may include attempting to acquire one or more nearby channels. The acquisition component 30 may perform the operations illustrated in block 72. The acquisition component 30 may perform an acquisition procedure on each of the nearby channels. The one or more nearby channels may be located within a second set spacing from the previously selected channel, on which the attempt to acquire a cell failed. The second set spacing may be based on, for example, uncertainty or flexibility in the spacing of carriers for a RAT. For example, WCDMA carriers may be spaced between 23-27 UARFCN apart. Accordingly, the UE 12 may set the second set spacing at 2 UARFCN or 400 kHz in each direction. The UE 12 may attempt to acquire these nearby channels. Due to the spreading of signals in a WCDMA system, signal strength measurements for nearby channels may be similar. If no cell is using a predicted channel having a high received signal strength as a center frequency, it may be likely that the cell is using one of the nearby channels as a center frequency. The acquisition component 12 may attempt to acquire a cell using the nearby channels in any order. For example, the acquisition component 12 may alternate between higher and lower channels starting closest to the predicted channels. If the acquisition component 12 acquires a cell using one of the nearby channels, the method 60 may proceed to block 74. If the UE 12 does not acquire one of the nearby channels, the method 60 may proceed to block 80.

In block 74, the method 60 may include adding one or more channels to an elimination subset. The elimination component 27 may perform the operations illustrated in block 74. The elimination component 27 may determine which channels to add to the elimination subset. The elimination subset may include channels that are unlikely to be used by another cell. For example, the elimination subset may include channels for which the UE 12 has already attempted an acquisition procedure. The elimination subset may also include channels located within a set spacing of a channel used by a successfully acquired cell. For example, if a WCDMA cell is using a channel as a center frequency, it is unlikely that another cell would use a channel within at least 22 UARFCN of the WCDMA cell. The acquisition component 12 may use a minimum spacing for the RAT as a conservative estimate of channels that may be eliminated. In an aspect, it may be unlikely that another cell would use a channel within 23-27 UARFCN of an acquired WCDMA cell. The number of channels that may be eliminated from a full PLMN search based on an acquired channel may be based on actual frequency planning, allocation, ownership or regulation within a geographic area or required by a standard.

In block 76, the method 60 may include determining whether the UE 12 should camp on the acquired cell. The UE 12 may communicate with the successfully acquired cell to determine whether camping is appropriate. For example, the UE 12 may request access to a network served by the acquired cell. A network access server may determine whether UE 12 is permitted access and direct UE 12 to camp on the acquired cell. If the UE 12 is directed to camp on the acquired cell, the method 60 may proceed to block 78. The UE may end a PLMN search at block 78, having found an acceptable cell. The UE 12 may then follow cell selection and handover procedures defined by the network. If the UE 12 is not directed to camp on the acquired cell, the method 60 may proceed to block 80. In an alternative aspect, the UE 12 may continue a PLMN search by proceeding to block 80 regardless of whether UE 12 is directed to camp on the acquired cell. For example, UE 12 may continue to search for other cells in order to determine a complete list of available PLMNs.

In block 80, the method 60 may include determining whether there are any additional channels in the predicted subset. The channel prediction component 24 may perform the operations illustrated in block 80. The channel prediction component 24 may determine whether an acquisition procedure has been attempted for each channel in the predicted subset. If the predicted subset includes additional channels that the UE 12 has not attempted to acquire, the method 60 may return to block 72 for a new channel, which may be selected based on the ranking. If all of the channels in the predicted subset have been searched, the method 60 may proceed to block 82.

In block 82, the method 60 may include removing the elimination subset from full PLMN set of channels. The elimination component 27 may remove the elimination subset from the full set of channels. Removing the elimination set may include removing a plurality of channels spaced less than the set spacing from a channel used by a successfully acquired cell. Removing the elimination set may also include removing the predicted subset from the full set of channels.

In block 84, the method 60 may include performing a full PLMN scan using the remaining channels of the full set of channels. The operations illustrated in block 84 may be performed by various components of UE 12 including the ranking component 28 and the acquisition component 30, for example. The full PLMN scan may use any method for scanning the remaining channels. For example, the full PLMN scan may include using the ranking component 28 to rank the remaining channels of the full set of channels according to signal strength, or may scan the full set of channels in ascending or descending order of channel number. The acquisition component 30 may be used to attempt to acquire each remaining channel. Because the channels of the elimination set have been removed, the full PLMN scan may be faster than scanning every possible channel.

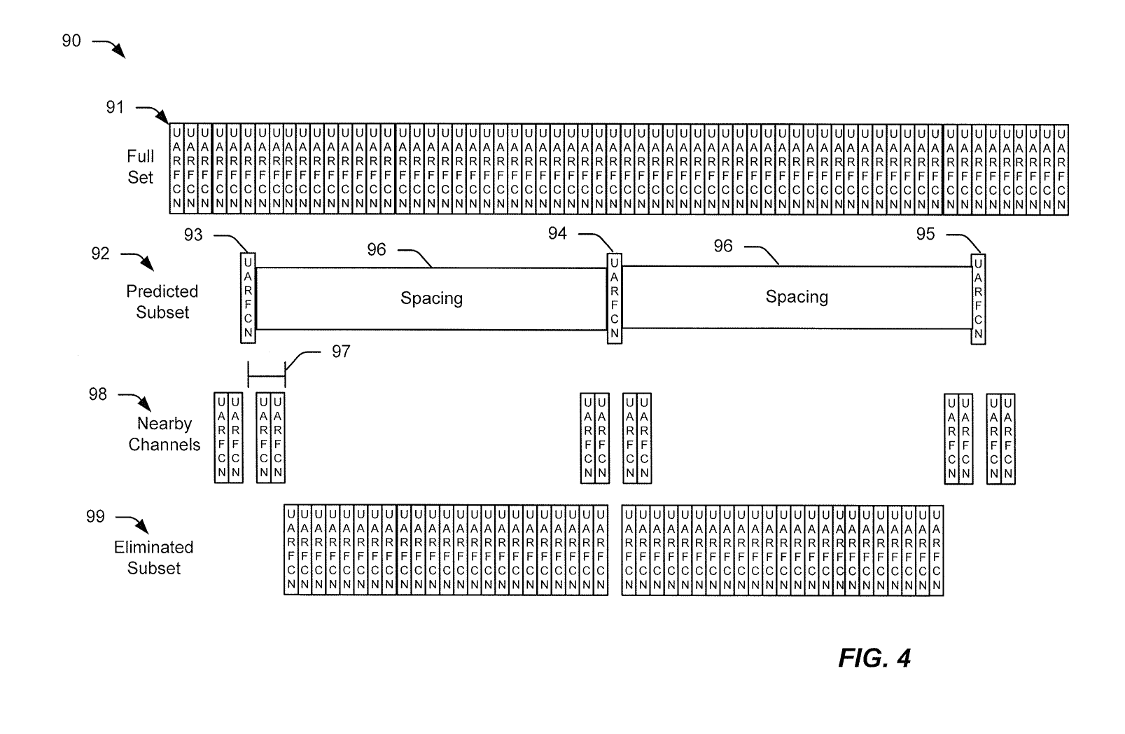

FIG. 4 is a diagram 90 illustrating sets of channels that may be utilized in a radio network. The full set 91 may include every channel usable by a wireless device such as UE 12. The full set 91 may be limited to a designated frequency band, or may include multiple bands. Within the full set 91, the channels may be adjacent, that is, the center frequencies of sequential channels may be spaced at a minimum channel spacing, for example, 200 kHz.

The predicted subset 92 may include channels located at different multiples of a first set spacing 96 from a previously acquired channel. For example, if channel 93 is a previously acquired channel, channel 94 is located at a set spacing 96 from channel 93, and channel 95 is located at a multiple of the set spacing from the channel 93. As discussed above, the set spacing 96 may be based on a RAT used by the UE or the previously acquired channel 93. For example, set spacing 96 is illustrated as 25 UARFCN.

The nearby channels 98 may represent channels near the predicted channels 93, 94, and 95. The nearby channels 98 may be adjacent channels to the predicted channels, or may be channels located within a second set spacing 97. The second set spacing 97 may be relatively small compared to the first set spacing 96. The second set spacing 97 may be defined by uncertainty in the first set spacing 96. For example, if the first set spacing may vary by 2 channels in each direction, the second set spacing 97 may be 2 channels.

The eliminated subset 99 may represent channels that are unlikely to be used by a different cell. For example, if a cell is acquired at a predicted channel 94, the eliminated subset 99 may include channels located within 22 UARFCN in either direction from predicted channel 94. The eliminated subset 99 may be excluded from a full PLMN scan without having been scanned. In an aspect, the eliminated subset 99 may further include channels that were successfully or unsuccessfully acquired. For example eliminated subset 99 may further include predicted channels 93 and 95, which may have also been scanned during an elimination scan and any nearby channels 98 that were also scanned during the elimination scan. If no cells were acquired during the elimination scan, the eliminated subset 99 may include the predicted subset 92 and the nearby channels 98 which may have been scanned during the elimination scan.

The eliminated subset 99 may illustrate time savings that may be achieved using an elimination scan according to the present disclosure. By eliminating a significant portion of the possible channels based on the detection of a single cell found at a predicted channel, a UE may more quickly determine the available cells provided by one or more PLMNs.

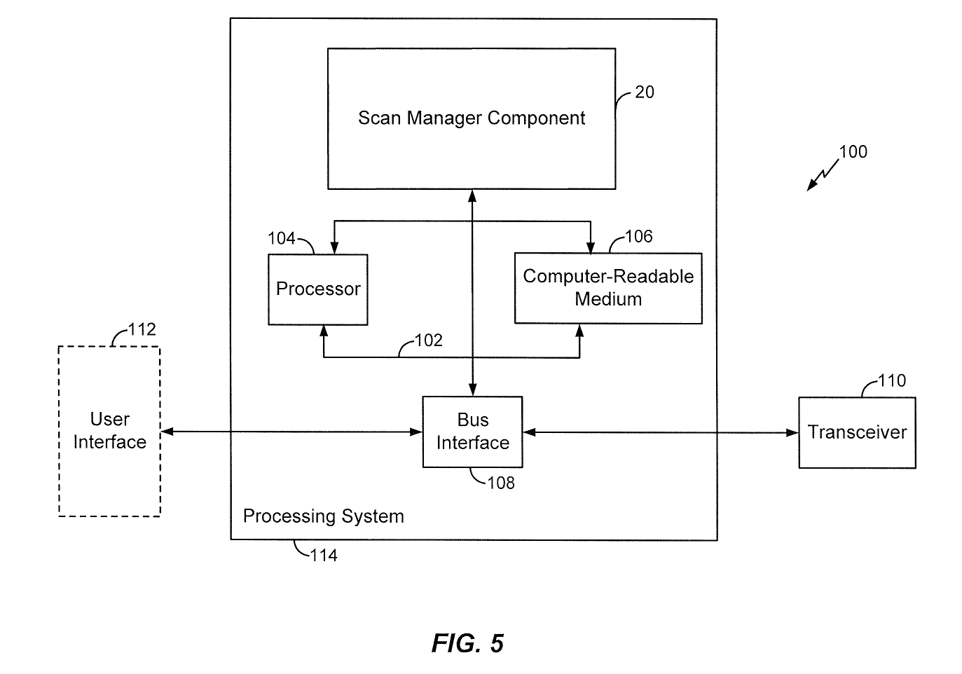

FIG. 5 is a conceptual diagram illustrating an example of a hardware implementation for an apparatus 100 employing a processing system 114. The apparatus 100 may correspond to the UE 12 (FIG. 1) and include a scan manager component 20. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 also may link scan manager component 20 to processor 104, and computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

In an aspect, the scan manager component 20 may be implemented by software executing on processor 104 and operating in conjunction with the computer-readable medium 106 and the bus 102.

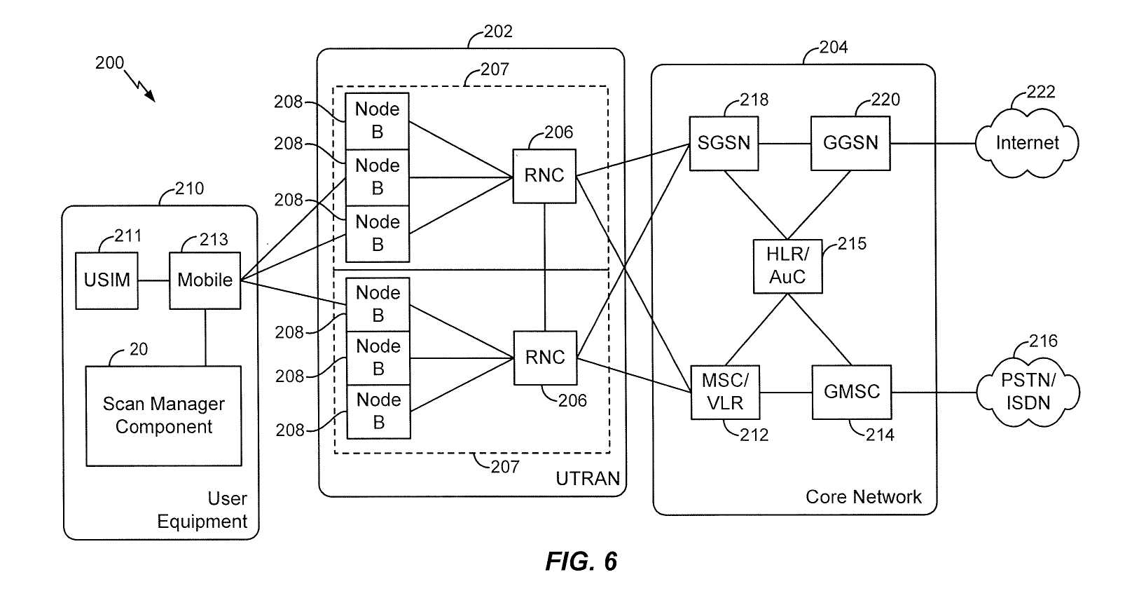

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UEs 210 may each correspond to the UE 12 (FIG. 1) and include a scan manager component 20. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information herein utilizes terminology introduced in Radio Resource Control (RRC) Protocol Specification, 3GPP TS 25.331 v9.1.0, incorporated herein by reference.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The UE 120 may further include a mobile component 213 for managing mobility of UE 510 among the Node Bs 508. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

In an aspect, the UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

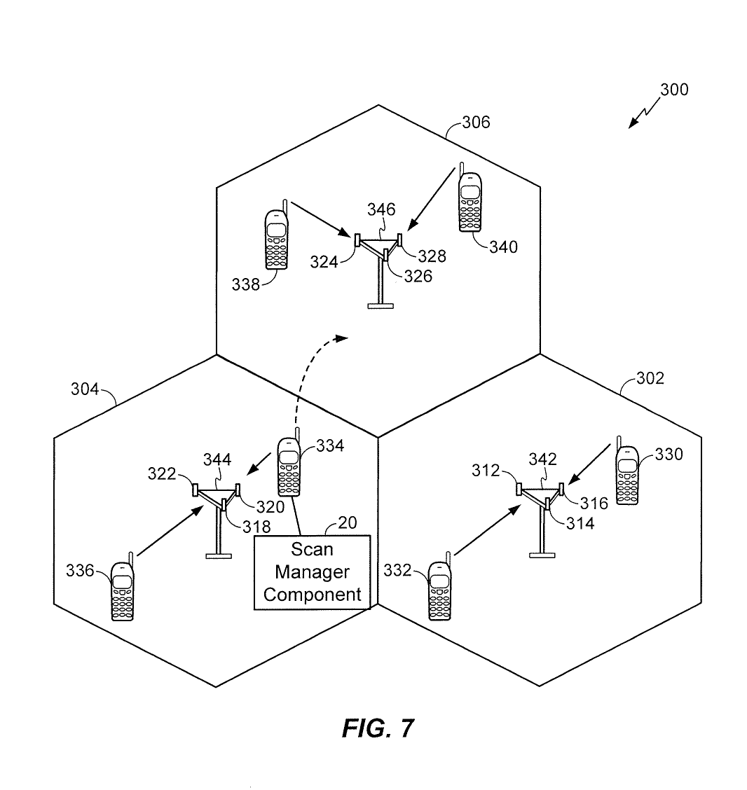

Referring to FIG. 7, an access network 300 in a UTRAN architecture is illustrated. The access network 300 may provide wireless communication access for UEs 330, 332, 334, 336, 338, 340, which may each be an example of the UE 12 in FIG. 1. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 6) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 6), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

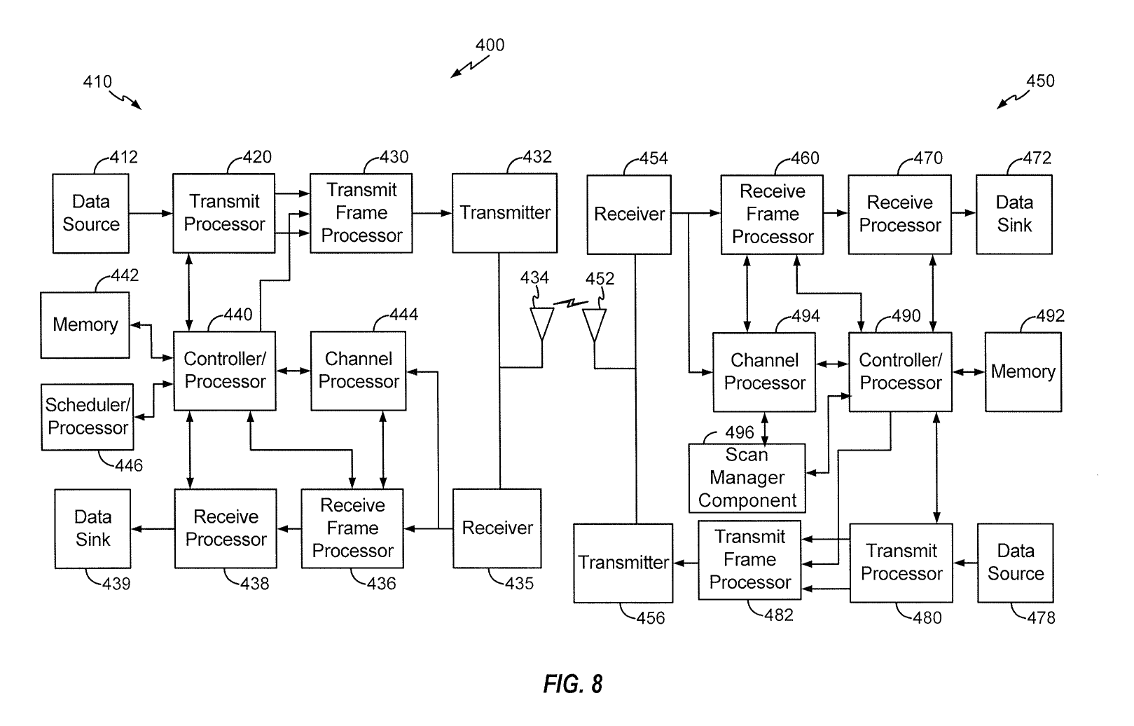

FIG. 8 is a block diagram of a Node B 410 in communication with a UE 450, where the Node B 410 may be the Node B 208 in FIG. 6 or one or the cells 14, 16, 18 in FIG. 1, and the UE 450 may be the UE 210 in FIG. 6 or the UE 12 in FIG. 1. The UE 450 may include a scan manager component 496 for performing a PLMN scan. In the downlink communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames. The scan manager component 496 may be functionally similar to the scan manager component 20. The scan manager component 496 may be implemented, for example, by the controller/processor 490 executing software to control other components for example, receiver 454, receive frame processor 460 receive processor 470 and channel processor 494. The software may reside in memory 492.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for performing a Public Land Mobile Network (PLMN) search, comprising:
determining a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels;
scanning the subset of channels to determine a signal strength of each channel in the subset;
ranking each channel in the subset according to the determined signal strength of the channel; and
attempting to acquire a cell using a channel in the subset based on the ranking.

2. The method of claim 1, further comprising:
determining a full set of channels to search within the frequency band;
determining that the attempt to acquire the cell using the channel in the subset was successful;
removing a plurality of channels from the full set of channels, the plurality of channels spaced less than the set spacing from the channel used by the successfully acquired cell; and
performing a full band scan by scanning the remaining channels of the full PLMN set.

3. The method of claim 2, further comprising removing the subset from the full set of channels before performing the full band scan.

4. The method of claim 1, wherein the set spacing is based on a planned carrier spacing for a radio access technology.

5. The method of claim 1, wherein the set spacing is 5 MHz.

6. The method of claim 1, further comprising:
determining that the attempt to acquire the cell using the channel in the subset has failed; and
attempting to acquire a cell using one or more channels located within a second set spacing from the channel for which the attempt to acquire failed.

7. The method of claim 6, wherein the second set spacing is 400 kHz.

8. The method of claim 1, wherein attempting to acquire a cell using a channel in the subset based on the ranking comprises attempting to acquire a cell using each channel in the subset having a signal strength greater than a threshold.

9. The method of claim 1, further comprising:
determining that the attempt to acquire the cell using the channel in the subset was successful;
camping on the successfully acquired cell; and
discontinuing the PLMN search without further attempts to acquire cells in the subset.

10. The method of claim 1, wherein the determining the subset of channels within a frequency band based on the stored identifier of the channel used by the previously acquired cell comprises:
determining a first stored identifier of a first channel used by a first cell within the frequency band and a second stored identifier of a second channel used by a second cell within the frequency band, the second stored identifier being greater than the first stored identifier;
determining that the subset includes a first plurality of channels having channel identifiers less than the second stored channel identifier and spaced at multiples of the set spacing from the first stored identifier; and
determining that the subset includes a second plurality of channels having channel identifiers greater than the second stored identifier and spaced at multiples of the set spacing from the second stored identifier.

11. The method of claim 1, further comprising reacquiring the previously acquired cell using the stored identifier of the channel before determining the subset to determine whether the stored identifier is applicable to a current geographic location.

12. An apparatus for wireless communication for performing a Public Land Mobile Network (PLMN) search, comprising:
means for determining a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels;
means for scanning the subset of channels to determine a signal strength of each channel in the subset;
means for ranking each channel in the subset according to the determined signal strength of the channel; and
means for attempting to acquire a cell using a channel in the subset based on the ranking.

13. The apparatus of claim 12, further comprising:
means for determining a full set of channels to search within the frequency band;
means for determining that the attempt to acquire the cell using the channel in the subset was successful;
means for removing a plurality of channels from the full set, the plurality of channels spaced less than the set spacing from the channel used by the successfully acquired cell; and
means for performing a full band scan by scanning the remaining channels of the full set.

14. The apparatus of claim 13, further comprising means for removing the subset of channels from the full set before performing the full band scan.

15. The apparatus of claim 12, wherein the set spacing is based on a planned carrier spacing for a radio access technology.

16. The apparatus of claim 12, wherein the set spacing is 5 MHz.

17. The apparatus of claim 12, further comprising:
means for determining that the attempt to acquire the cell using the channel in the subset has failed; and
means for attempting to acquire a cell using one or more channels located within a second set spacing of the failed channel.

18. The apparatus of claim 17, wherein the second set spacing is 400 kHz.

19. The apparatus of claim 12 wherein the means for attempting to acquire a cell using a channel in the subset based on the ranking comprises means for attempting to acquire a cell using each channel in the subset having a signal strength greater than a threshold.

20. The apparatus of claim 12, further comprising means for determining that the attempt to acquire the cell using the channel in the subset was successful, camping on the successfully acquired cell, and discontinuing the PLMN search without further attempts to acquire cells in the subset.

21. The apparatus of claim 12, wherein the means for determining a subset of channels within a frequency band based on a stored channel of a previously acquired cell is configured to:
determine a first identifier of a first channel used by a first cell within the frequency band and a second identifier of a second channel used by a second cell within the frequency band, the second identifier being greater than the first identifier;
determine that the subset includes a first plurality of channels having identifiers less than the second channel identifier and spaced at multiples of the set spacing from the first stored identifier; and
determine that the subset includes a second plurality of channels having identifiers greater than the second channel and spaced at multiples of the set spacing from the second stored channel identifier.

22. The apparatus of claim 12 further comprising: means for reacquiring the previously acquired cell using the identifier of the channel before determining the subset in order to determine whether the stored identifier of the channel is applicable to a current geographic location.

23. A computer program product, comprising:
a non-transitory computer-readable medium comprising code for:
determining a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels;
scanning the subset of channels to determine a signal strength of each channel in the subset;
ranking the each channel in the subset according to the determined signal strength of the channel; and
attempting to acquire a cell using a channel of the subset based on the ranking.

24. An apparatus for wireless communication, comprising:
at least one processor; and
a memory coupled to the at least one processor, wherein the at least one processor is configured to:
determine a subset of channels within a frequency band based on a stored identifier of a channel used by a previously acquired cell, each channel in the subset being spaced from the channel used by the previously acquired cell by a different multiple of a set spacing, the set spacing being greater than a spacing between adjacent channels;
scan the subset of channels to determine a signal strength of each channel;
rank each channel in the subset of channels according to the signal strength; and
attempt to acquire a cell using a channel in the subset based on the ranking.

25. The apparatus of claim 24, wherein the processor is further configured to:
determine a full set of channels to search within the frequency band;
determine that the attempt to acquire the cell using the channel in the subset was successful;
remove a plurality of channels from the full set of channels, the plurality of channels spaced less than the set spacing from the channel used by the successfully acquired cell; and
perform a full band scan by scanning the remaining channels of the full set.

26. The apparatus of claim 25, wherein the set spacing is based on a planned carrier spacing for a radio access technology.

27. The apparatus of claim 25, wherein the set spacing is 5 MHz.

28. The apparatus of claim 25, wherein the processor is further configured to:
determine that the attempt to acquire the cell using channel in the subset has failed; and
attempt to acquire a cell using one or more channels located within a second set spacing of the failed channel.

29. The apparatus of claim 28, wherein the second set spacing is 400 kHz.

30. The apparatus of claim 28, wherein the processor is configured to attempt to acquire a cell using a channel of the subset based on the ranking by attempting to acquire a cell using each channel of the subset having a signal strength greater than a threshold.
